(19) United States
(12) Patent Application Publication
(10) Pub. No.: US 2025/0390155 A1
(43) Pub. Date: Dec. 25, 2025

(54) METHOD FOR DISPLAYING AMOUNT OF CHARGE, NON-TRANSITORY COMPUTER-READABLE STORAGE MEDIUM, AND TERMINAL DEVICE

(71) Applicant: GUANGDONG OPPO MOBILE TELECOMMUNICATIONS CORP., LTD., Dongguan, Guangdong (CN)

(72) Inventor: Zhibin HE, Dongguan, Guangdong (CN)

(73) Assignee: GUANGDONG OPPO MOBILE TELECOMMUNICATIONS CORP., LTD., Dongguan, Guangdong (CN)

(21) Appl. No.: 18/876,517

(22) PCT Filed: Apr. 6, 2022
(86) PCT No.: PCT/CN2022/085320

§ 371 Date: Apr. 22, 2025

(30) Foreign Application Priority Data
Apr. 14, 2021 (CN) 202110400110.7

(51) Int. Cl. G06F 1/28; G06F 9/54

(52) U.S. Cl. CPC G06F 1/28; G06F 9/542

(57) ABSTRACT

The embodiments of the present application disclose a method and apparatus for displaying the amount of charge, a storage medium, and a terminal device. The method is applied to a terminal device, the terminal device comprising a first operating system and a second operating system, and the power consumed by the terminal device running the first operating system being less than the power consumed by the terminal device running the second operating system. The method comprises: when a first operating system is switched to a second operating system, acquiring first charge information before the first operating system is switched; and the second operating system determining first initial charge information on the basis of the first charge information, and displaying the first initial charge information in the second operating system. By adopting the embodiments of the present invention, jumps can be prevented from occurring in the display of the amount of charge during system switching, and a smooth transition in displaying the amount of charge is achieved.

### CROSS REFERENCE TO RELATED APPLICATIONS

This application claims priority to Chinese Patent Application No. 202110400110.7 filed on Apr. 14, 2021, the entire contents of which are incorporated herein by reference.

### TECHNICAL FIELD

Embodiments of the present disclosure relate to the field of computer technologies, and in particular, to a method for displaying a battery level, an apparatus for displaying a battery level, a storage medium, and a terminal device.

### BACKGROUND

With the continuous development of intelligent terminal devices, dual-system (or multi-system) terminals are gradually becoming popular. A dual-system terminal refers to a terminal device equipped with two different processor chips, and each of the processor chips runs an operating system. Each operating system has its own individual function for calculating the battery level, and accuracies of battery-level calculation are different for different operating systems. During the use of the terminal device, when the terminal device is switched between the two operating systems, since the two operating systems use different methods for calculating the battery level and have different initial conditions, the battery level displayed on the interface of the terminal device may jump or hop or change sharply when switching between the two operating systems.

### SUMMARY

Some embodiments of the present disclosure provide a method for displaying a battery level, an apparatus for displaying a battery level, a storage medium, and a terminal device, which may achieve a smooth transition in displaying the battery level during the system switch. The technical solutions may include the following.

In a first aspect, some embodiments of the present disclosure provide a method for displaying a battery level performed by a terminal device. The terminal device includes a first operating system and a second operating system. Power consumed by the terminal device running the first operating system is less than power consumed by the terminal device running the second operating system. The method includes:
obtaining first battery-level information in response to the first operating system being switched to the second operating system, where the first battery-level information is battery-level information before the first operating system is switched; and
determining, by the second operating system, first initial battery-level information based on the first battery-level information; and displaying the first initial battery-level information in the second operating system.

In a second aspect, some embodiments of the present disclosure provide an apparatus for displaying a battery level. The apparatus for displaying a battery level includes a first operating system, configured to:
obtain first battery-level information in response to the first operating system being switched to the second operating system, where the first battery-level information is battery-level information before the first operating system is switched; and
determine first initial battery-level information based on the first battery-level information; and display the first initial battery-level information in the second operating system.

In a third aspect, some embodiments of the present disclosure provide a storage medium, the storage medium stores a plurality of instructions which is configured to be loaded by a processor to perform the aforementioned method.

In a fourth aspect, some embodiments of the present disclosure provide a terminal device. The terminal device includes a processor and a memory storing a computer program. The computer program is configured to be loaded and executed by the processor to perform the aforementioned method.

The technical solutions provided by some embodiments of the present disclosure may at least have the following effects.

In some embodiments of the present disclosure, the terminal device includes a first operating system and a second operating system. Power consumed by the terminal device running the first operating system is less than power consumed by the terminal device running the second operating system. The method includes: obtain first battery-level information in response to the first operating system being switched to the second operating system, where the first battery-level information is battery-level information before the first operating system is switched; and determining, by the second operating system, first initial battery-level information based on the first battery-level information; and displaying the first initial battery-level information in the second operating system. When the terminal device is switched from one of the operating systems to another of the operating systems, the another operating system after switching may determine the initial battery-level display of the another operating system after switching based on the battery-level information displayed by the operating system before switching, reducing the occurrence of jumping or hopping of the battery-level display, and ensuring a smooth transition in displaying the battery level when the terminal device is switched from the second operating system to the first operating system.

### BRIEF DESCRIPTION OF THE DRAWINGS

To illustrate the technical solutions in some embodiments of the present disclosure or the related art, a brief introduction to the drawings used in some embodiments of the present disclosure or the related art is provided below. It is evident that the drawings described below are only some of the embodiments of the present disclosure in some embodiments of the present disclosure. For those skilled in the art, other drawings may be derived based on the following drawings without creative work.

FIG. 1 is a diagram illustrating a product architecture of a method for displaying a battery level according to some embodiments of the present disclosure.

FIG. 2 is schematic flowchart illustrating a method for displaying a battery level according to some embodiments of the present disclosure.

FIG. 3 is schematic flowchart illustrating a method for displaying a battery level according to some embodiments of the present disclosure.

FIG. 4 is a schematic view illustrating an example where a difference in battery-level information is greater than a threshold according to some embodiments of the present disclosure.

FIG. 5 is a schematic view illustrating an example where a difference in battery-level information is less than a threshold according to some embodiments of the present disclosure.

FIG. 6 is a sequence diagram of a method for displaying a battery level according to some embodiments of the present disclosure.

FIG. 7 is a sequence diagram of a method for displaying a battery level according to some embodiments of the present disclosure.

FIG. 8 is a structural block diagram of an apparatus for displaying a battery level according to some embodiments of the present disclosure.

FIG. 9 is a schematic structural diagram of a terminal device according to some embodiments of the present disclosure.

FIG. 10 is a schematic structural diagram of an operating system and user space according to some embodiments of the present disclosure.

FIG. 11 is a diagram illustrating an architecture of an Android operating system according to some embodiments of the present disclosure.

FIG. 12 is a diagram illustrating an architecture of an IOS operating system according to some embodiments of the present disclosure.

### DETAILED DESCRIPTION

Technical solutions of some embodiments of the present disclosure will be clearly and completely described below in conjunction with the accompanying drawings of some embodiments of the present disclosure. It is obvious that, the described embodiments are merely part of the embodiments of the present disclosure and not all of the embodiments. All other embodiments obtained by those skilled in the art based on the embodiments of the present disclosure without creative efforts shall fall within the protection scope of the present disclosure.

In the description of the present disclosure, it should be understood that terms “first”, “second”, etc., are merely configured for descriptive purposes and are not to be construed as indicating or implying relative importance. In the description of the present disclosure, it should be noted that, unless otherwise expressly provided and limited, terms “including”, “having”, and any variations thereof are intended to cover non-exclusive inclusion. For example, a process, method, system, product, or apparatus that includes a series of operations or units is not limited to the operations or units listed, but may include operations or units that are not listed, or may include other operations or units that are inherent to the process, method, product, or apparatus. For those skilled in the art, the specific meaning of the above terms in some embodiments of the present disclosure may be understood based on specific conditions. In addition, in the description of the present disclosure, unless otherwise specified, “a plurality of” refers to two or more than two. A term “and/or” describes association relationship between associated objects, indicating that three types of relationships may exist. For example, A and/or B may indicate that A is present alone, both A and B are present, and B is present alone. The character “/” generally indicates that the relationship between an object before the character and an object after the character is “or”.

With the development of science and technology, types of terminal devices are becoming more and more abundant. In order to meet the diversified functional requirements, some terminal devices tend to use two operating systems to operate alternately and interactively, where one operating system A of the two operating system runs on a processor with rich functions and strong processing power. The other operating system B of the two operating system tends to run on a processor with simple functions and weak processing power, but the processor with weak processing power generally has very low power consumption, which may complete some simple tasks and meanwhile greatly ensure the battery life of the terminal device. In the related art, when the terminal device is switched from the operating system A to the operating system B, since the function of the operating system B is simple, battery-level information may not be displayed or only schematic information is displayed without displaying specific battery-level information in this case, and the user experience is poor. When the terminal device is switched from the operating system B to the operating system A, the operating system A needs to recalculate the battery-level information since the specific battery-level information is not displayed in the operating system B. However, recalculating the battery level takes a certain amount of time and consumes a lot of power, such that the battery level is prone to jump or hop, and the user experience is degraded.

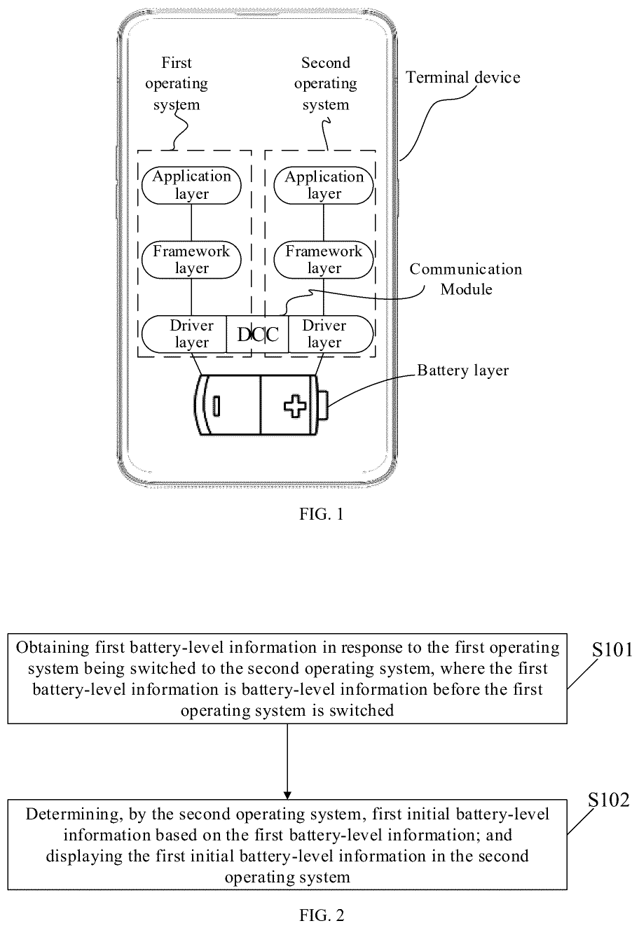

In some embodiments, as shown in FIG. 1, FIG. 1 is a diagram illustrating a system structure of a method for displaying a battery level according to some embodiments of the present disclosure. As shown in FIG. 1, the method for displaying a battery level in some embodiments of the present disclosure may be applied to or performed by a terminal device with a system structure as shown in FIG. 1. The terminal device may include, but is not limited to, a mobile phone, a handheld device, an in-vehicle device, a personal computer, a laptop computer, a smart wearable device, and other terminal devices with multiple operating systems.

The system structure shown in FIG. 1 may include a first operating system, a second operating system, and a battery layer. The first operating system may include a driver layer, a framework layer, and an application layer. The second operating system may have the same structure as the first operating system, and may also include a driver layer, a framework layer, and an application layer. The first operating system and the second operating system may communicate with each other through a dual-core communication (DCC) module.

The battery layer refers to a battery of the terminal device. The battery of the terminal device may be configured to store electric energy, supply power to the terminal device and ensure the normal operation of the terminal device. In some embodiments of the present disclosure, the battery of the terminal device may provide energy sources for stable operations of the first operating system and the second operating system, respectively. The battery may of the terminal device be connected to the driver layer of the first operating system and the driver system of the second operating system, respectively.

The driver layer may include a battery drive and a DCC module. The battery drive may be configured to manage the charging and discharging of the battery and calculate the battery level. The driver layer of the first operating system and the driver layer of the second operating system may each obtain the battery-level information of the battery, and display the battery-level information in the application layer of the corresponding operating system. The DCC module is mainly configured for the data exchange between the two operating systems. The battery-level information obtained by the driver layer may also be transmitted interactively between the two operating systems through the DCC module; for example, in response to the terminal device being switched from the second operating system to the first operating system, the second operating system may synchronize and send the battery-level information that is currently obtained by the second operating system to the DCC module of the first operating system through the DCC module of the second operating system, and the DCC module of the first operating system may send the obtained battery-level information to the battery drive of the first operating system as initial battery-level information.

In each of the two operating systems, the driver layer may send the battery-level information to the application layer through the frame layer for display. The frame layer is configured for the logic of information transmission between the driver layer and the application layer. The application layer is configured to display the battery-level information in the display interface.

Based on the system structure shown in FIG. 1, a method for displaying a battery level according to some embodiments of the present disclosure will be described in detail below in conjunction with FIG. 2 to FIG. 7.

FIG. 2 is schematic flowchart illustrating a method for displaying a battery level according to some embodiments of the present disclosure. Some embodiments of the present disclosure are described by taking the terminal device being switched from the first operating system to the second operating system as an example. As shown in FIG. 2, the method for displaying a battery level may include operations executed by the following blocks S101 to S102.

At block S101, first battery-level information may be obtained, and the first battery-level information is battery-level information before the first operating system is switched. The first battery-level information may be obtained in response to the first operating system being switched to the second operating system.

It may be understood that, the process of switching from the first operating system to the second operating system may include a process of switching back from first operating system to the second operating system after the terminal device is switched from the second operating system to the first operating system.

In some embodiments, the second operating system refers to an operating system running on a processor with rich functions and strong processing power. An accuracy of battery-level calculation performed by the second operating system is higher than an accuracy of the battery-level calculation performed by the first operating system. In a case where the second operating system is completely shut down, the terminal device only runs on the first operating system. In this case, the second operating system may obtain the first battery-level information, and the first battery-level information is the battery-level information before the first operating system is switched to the second operating system. The first battery-level information may be obtained in response to the terminal device being switched from the first operating system to the second operating system.

The first battery-level information may be obtained by the following operations. The second operating system may send a request for obtaining the battery-level information before the first operating system is switched to the second operating system, the first operating system may receive the request for obtaining the battery-level information and send the first battery-level information to the second operating system through the DCC module, and the second operating system may receive second battery-level information and return or send a receiving acknowledgement information back through the DCC modules.

At block S102, the second operating system may determine first initial battery-level information based on the first battery-level information, and display the first initial battery-level information in the second operating system.

The first initial battery-level information refers to the battery-level information initially displayed in the second operating system in response to the terminal device being switched from the first operating system to the second operating system.

In some embodiments of the present disclosure, when the terminal device is switched from the first operating system to the second operating system, the first battery-level information, which is before the first operating system is switched to the second operating system, may be obtained, and then the second operating system may determine the first initial battery-level information based on the first battery-level information and display the first initial battery-level information in the second operating system. When the terminal device is switched from one of the operating systems to another of the operating systems, the another operating system after switching may determine the initial battery-level display of the another operating system after switching based on the battery-level information displayed by the operating system before switching, reducing the occurrence of jumping or hopping of the battery-level display, and ensuring a smooth transition in displaying the battery level when the terminal device is switched from the first operating system to the second operating system.

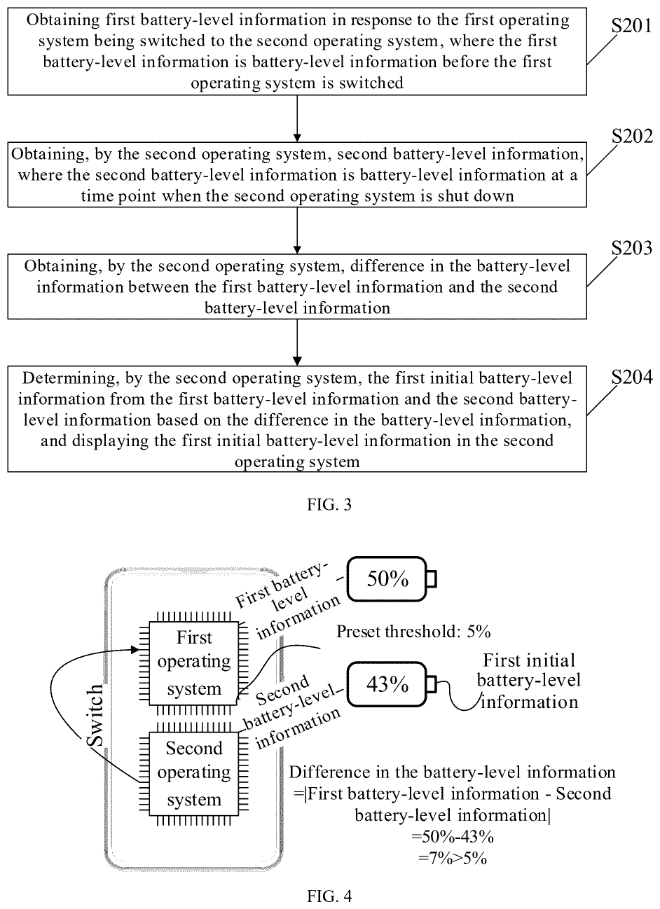

FIG. 3 is schematic flowchart illustrating a method for displaying a battery level according to some embodiments of the present disclosure. Some embodiments of the present disclosure are described by taking the terminal device being switched from the first operating system to the second operating system as an example. As shown in FIG. 3, the method for displaying a battery level may include operations executed by the following blocks S201 to S204.

At block S201, first battery-level information may be obtained, and the first battery-level information is battery-level information before the first operating system is switched. The first battery-level information may be obtained in response to the first operating system being switched to the second operating system.

Details to the block S201 may refer to the description of the block S101 in some embodiments, and will not be repeated herein.

At block S202, the second operating system may obtain second battery-level information, and the second battery-level information is battery-level information at a time point when the second operating system is shut down.

In some embodiments, when the first operating system is switched to the second operating system, the second operating system may obtain the second battery-level information, and the second battery-level information is the battery-level information is at the time point when the second operating system is shut down.

The second battery-level information refers to the battery-level information calculated before the second operating system is shut down in response to the terminal device being switched from the second operating system to the first operating system. The shutdown of the second operating system may include two situations. In the first situation, the terminal device may be switched from the second operating system to the first operating system, and the second operating system is shut down. In the second situation, the terminal device may be switched from the second operating system to the first operating system, the second operating system may continue to run in the background for a period of time, and then the second operating system is shut down. The shutdown of the second operating system may be understood as the second operating system neither running in the foreground nor the background.

At block S203, the second operating system may obtain difference in the battery-level information between the first battery-level information and the second battery-level information.

In some embodiments, the second operating system may calculate and obtain the difference in the battery-level information between the first battery-level information and the second battery-level information based on the first battery-level information and the second battery-level information.

The difference in the battery-level information may be the absolute value of the difference between the first battery-level information and the second battery-level information.

Obviously, the first battery-level information is the battery-level information before the first operating system is switched to the second operating system, and the second battery-level information is the battery-level information before the second operating system is shut down. The difference in the battery-level information is configured to reflect the power consumed by the terminal device in a case where only the first operating system is run on the terminal device. In case that the difference in the battery-level information is small, it indicates that no greater power is consumed or supplemented in the case where only the first operating system is run on the terminal device. In case that the difference in the battery-level information is great, it indicates that the battery-level information changes greatly in the case where only the first operating system is run on the terminal device, and the reason may include the terminal device running the first operating system for a long time or the terminal device being charged when running the first operating system.

At block S204, the second operating system may determine the first initial battery-level information from the first battery-level information and the second battery-level information based on the difference in the battery-level information, and display the first initial battery-level information in the second operating system.

The first initial battery-level information refers to the battery-level information initially displayed in the second operating system in response to the first operating system being switched to the second operating system.

In some embodiments, a threshold may be set, and the second operating system may determine the first initial battery-level information from the first battery-level information and the second battery-level information based on the difference in the battery-level information and the threshold.

In a case where the difference in the battery-level information is greater than the threshold, the first battery-level information is determined as the first initial battery-level information, and the first initial battery-level information is displayed in the display interface based on the second operating system.

It may be understood that, after the second operating system is shut down, the terminal device runs the first operating system and calculates the battery-level information by the first operating system. In a case where the terminal device runs the first operating system for a long time or the terminal device is charged when the first operating system is run on the terminal device, a large change may arise in the battery-level information, and the amount of change is the difference in the battery-level information. In a case where the difference in the battery-level information is greater than the threshold, the first battery-level information is determined as the first initial battery-level information, the battery-level information displayed in the first operating system when the terminal device runs the first operating system before the system switch is determined as the first battery-level information, and the first battery-level information is also taken as the battery-level information displayed in the second operating system when the terminal device runs the second operating system after the system switch.

FIG. 4 is a schematic view illustrating an example where a difference in battery-level information is greater than a threshold according to some embodiments of the present disclosure.

As shown in FIG. 4, in a case where the second battery-level information before the second operating system is shut down is 50%, the first battery-level information before the first operating system is switched to the second operating system is 43%, and the preset threshold is 5%, in response to the terminal device being switched from the first operating system to the second operating system, the difference in the battery-level information in this case is 7% since the difference in the battery-level information is equal to the absolute value of the difference between the second battery-level information and the first battery-level information, and the difference in the battery-level information is greater than the threshold. In this case, the first battery-level information is displayed in the display interface as the first initial battery-level information.

In some embodiments, in a case where the difference in the battery-level information is greater than the threshold, the second operating system may calculate current battery-level information and determine the current battery-level information as the first initial battery-level information.

It is not difficult to understand that, since the terminal device runs the first operating system in a case where the second operating system being completely shut down, the calculation of the battery-level information based on or performed by the first operating system may be rough, the calculated battery-level information may be inaccurate, and the first battery-level information obtained by the second operating system is inaccurate when the terminal device is switched from the first operating system to the second operating system. In this case, if the difference in the battery-level information is greater than the threshold, the current battery-level information of the terminal device is recalculated based on the second operating system, the current battery-level information is determined as the first initial battery-level information, the difference between the current battery-level information and the first battery-level information is not great, and the current battery-level information is more accurate than the second battery-level information.

The current battery-level information of the terminal device may be recalculated based on the second operating system by the following operations. The second operating system may first initialize the battery drive, and then use the battery-level calculation algorithm of the second operating system to calculate the remaining battery-level information in response to the terminal device being switched from the first operating system to the second operating system, and determine the remaining battery-level information as the current battery-level information.

In a case where the difference in the battery-level information is less than or equal to the threshold, the second battery-level information is determined as the initial battery-level information, and the first initial battery-level information is displayed in the display interface by the second operating system.

It is not difficult to understand that, after the second operating system is shut down, the terminal device runs the first operating system and calculates the battery-level information based on the first operating system. On the one hand, since the power consumption of the terminal device is extremely low when the terminal device runs the first operating system, the battery-level information will not change greatly in case that the terminal device runs the first operating system for a short time; on the other hand, a certain error may occur since the calculation method for calculating the battery-level information of the battery of the terminal device based on the first operating system is rough. Therefore, in a case where the difference in the battery-level information is less than or equal to the threshold, the second battery-level information saved before the second operating system is shut down may be used as the first initial battery-level information.

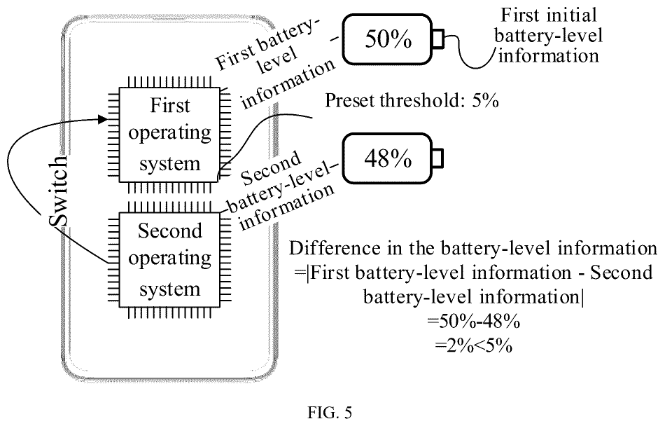

FIG. 5 is a schematic view illustrating an example where a difference in battery-level information is less than a threshold according to some embodiments of the present disclosure.

As shown in FIG. 5, in a case where the second battery-level information before the second operating system is shut down is 50%, the first battery-level information before the first operating system is switched to the second operating system is 48%, and the preset threshold is 5%, in response to the terminal device being switched from the first operating system to the second operating system, the difference in the battery-level information in this case is 2% since the difference in the battery-level information is equal to the absolute value of the difference between the first battery-level information and the second battery-level information, and the difference in the battery-level information is less than the threshold. In this case, the second battery-level information is displayed in the display interface as the first initial battery-level information.

In some embodiments of the present disclosure, when the first operating system is switched to the second operating system, the second battery-level information at the time point when the second operating system is shut down and the first battery-level information before the first operating system is switched to the second operating system are obtained, the difference in the battery-level information is obtained based on the first battery-level information and the second battery-level information, the threshold is set, the first initial battery-level information is determined based on the difference in the battery-level information, and the first initial battery-level information is displayed in the display interface. In some embodiments, the battery-level information displayed after the final switch may be determined based on the battery-level information corresponding to the two operating systems and the difference in the battery-level information, instead of directly calculating and displaying the battery level by the operating system after switching or before switching, the occurrence of jumping or hopping of the battery-level display may be reduced, and the smooth transition in displaying the battery level in response to the terminal device being switched from the first operating system to the second operating system may be ensured. In some embodiments, in a case where the difference in the battery-level information is greater than the threshold, the current battery-level information of the terminal device may be recalculated based on the second operating system, and the current battery-level information is determined as the first initial battery-level information, so as to ensure the accuracy of the battery-level display.

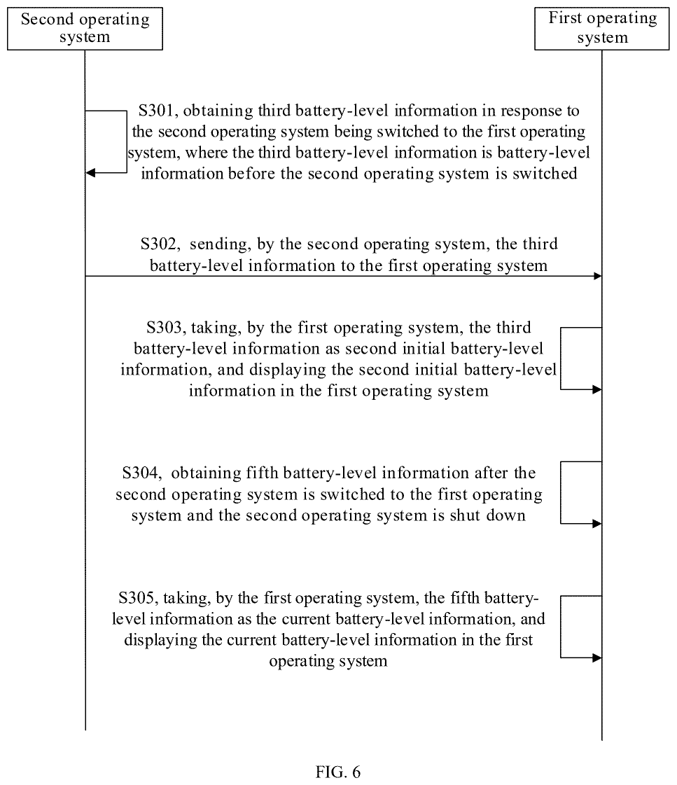

FIG. 6 is a sequence diagram of a method for displaying a battery level according to some embodiments of the present disclosure. Some embodiments of the present disclosure are described by taking the terminal device being switched from the second operating system to the first operating system as an example. As shown in FIG. 6, the method for displaying a battery level may include operations executed by the following blocks S301 to S305.

At block S301, third battery-level information may be obtained, and the third battery-level information is battery-level information before the second operating system is switched to the first operating system. The third battery-level information may be obtained in response to the second operating system being switched to the first operating system.

The third battery-level information is the battery-level information displayed in the display interface before the second operating system is switched to the first operating system.

It may be understood that, the process of switching from the second operating system to the first operating system may include a process in which the terminal device runs the second operating system by default when the terminal device is powered on, and then the terminal device is switched from the second operating system to the first operating system after the terminal device is powered on; or it may also include a process in which the terminal device is switched from the first operating system to the second operating system and then switched back from the second operating system to the first operating system.

At block S302, the second operating system may send the third battery-level information to the first operating system.

In some embodiments, the calculation of the battery level performed by the second operating system is accurate, while the calculation of the battery level performed by the first operating system is rough. Thus, in response to the terminal device being switched from the second operating system to the first operating system, the second operating system may send the third battery-level information to the first operating system through the DCC modules, such that the battery-level information received by the first operating system may be more accurate.

At block S303, the first operating system may take the third battery-level information as second initial battery-level information, and display the second initial battery-level information in the first operating system.

The second initial battery-level information refers to the battery-level information initially displayed in the first operating system in response to the terminal device being switched to the first operating system.

In some embodiments, the first operating system receives the third battery-level information, the third battery-level information is calculated by the second operating system and has a higher accuracy, and the first operating system determines the third battery-level information as the second initial battery-level information and further displays the second initial battery-level information in the display interface.

It is not difficult to understand that, when the terminal device runs the second operating system, the battery-level information calculated based on the second operating system is more accurate, and the calculation of the battery level performed by the first operating system is rough and not accurate. Therefore, when the second operating system is switched to the first operating system, the first operating system may take the third battery-level information before the second operating system is switched to the first operating system as the second initial battery-level information of the first operating system.

At block S304, after the second operating system is switched to the first operating system and the second operating system is shut down, fifth battery-level information is obtained.

The fifth battery-level information refers to the battery-level information calculated based on the first operating system.

In some embodiments, after the second operating system is switched to the first operating system and the second operating system is shut down, the terminal device only runs the first operating system, and the second operating system is not run in the foreground or in the background. In this case, the battery-level information is continuously calculated and updated based on the first operating system to obtain the fifth power level information.

At block S305, the first operating system may take the fifth battery-level information as the current battery-level information, and display the current battery-level information in the first operating system.

In some embodiments of the present disclosure, when the second operating system is switched to the first operating system, the third battery-level information before the second operating system is switched to the first operating system is obtained, then the third battery-level information is taken as the second initial battery-level information of the first operating system in response to the terminal device being switched to the first operating system, and the second initial battery-level information is displayed in the display interface. The operating system after switching may directly use and display the battery-level information displayed by the operating system before switching, which achieves the smooth transition in displaying the battery level in response to the second operating system being switched to the first operating system. In addition, after the second operating system is switched to the first operating system and the second operating system is shut down, the first operating system may continuously calculate and update the battery-level information to obtain the fifth battery-level information, the first operating system may further display the fifth battery-level information in the display interface of the first operating system, which reduces the occurrence of failure in displaying the battery-level information due to the shutdown of the second operating system and further ensures the display of the battery-level information.

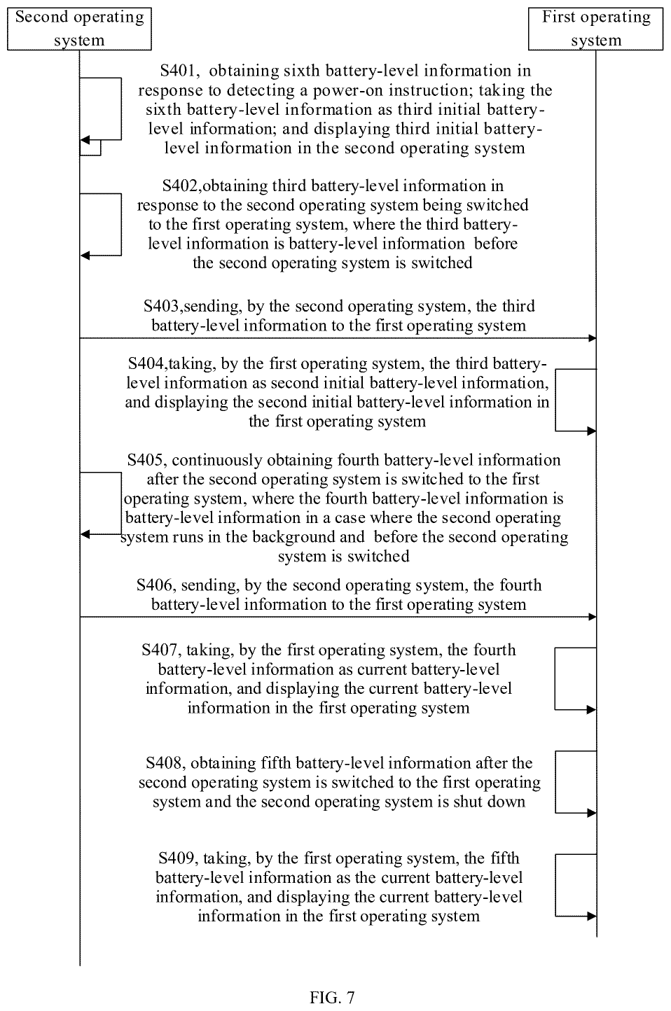

FIG. 7 is a sequence diagram of a method for displaying a battery level according to some embodiments of the present disclosure. Some embodiments of the present disclosure are described by taking the complete process of the terminal device from powering on the terminal device and residing in the second operating system to switching from the first operating system to the second operating system as an example. As shown in FIG. 7, the method for displaying a battery level may include operations executed by the following blocks S401 to S409.

At block S401, in response to detecting a power-on instruction, sixth battery-level information may be obtained, the sixth battery-level information may be taken as the third initial battery-level information, and third initial battery-level information may be displayed in the second operating system.

The sixth battery-level information refers to the battery-level information calculated by the second operating system at a time point when the terminal device is just powered on.

The third initial battery-level information refers to the battery-level information initially displayed in the display interface at the time point when the terminal device is just powered on.

In some embodiments, the terminal device runs the second operating system at the time point when the terminal device is just powered on. The current battery-level information may be calculated based on the second operating system to obtain the sixth battery-level information, and the sixth battery-level information may be taken as the third initial battery-level information and displayed in the display interface.

At block S402, the third battery-level information before the second operating system is switched to the first operating system may be obtained. The third battery-level information may be obtained in response to the second operating system being switched to the first operating system.

Details to the block S402 may refer to the description of the block S301 in some embodiments, and will not be repeated herein.

At block S403, the second operating system may send the third battery-level information to the first operating system.

Details to the block S403 may refer to the description of the block S302 in some embodiments, and will not be repeated herein.

At block S404, the first operating system may take the third battery-level information as the second initial battery-level information, and display the second initial battery-level information in the first operating system.

Details to the block S404 may refer to the description of the block S303 in some embodiments, and will not be repeated herein.

At block S405, after the second operating system is switched to the first operating system, fourth battery-level information is continuously obtained, and the fourth battery-level information is the battery-level information in a case where the second operating system runs in the background and before the second operating system is shut down.

The fourth battery-level information refers to the battery-level information of the battery calculated in a case where the second operating system runs in the background after the second operating system is switched to the first operating system.

In some embodiments, after the second operating system is switched to the first operating system, the second operating system runs in the background. At this time, the second operating system continuously calculates the battery-level information to obtain the fourth battery-level information.

At block S406, the second operating system may send the fourth battery-level information to the first operating system.

In some embodiments, the second operating system may continuously send the fourth battery-level information to the first operating system through the DCC modules.

In a feasible implementation, the terminal device runs the first operating system, the second operating system runs in the background, the second operating system continuously calculates and obtains the fourth battery-level information, and sends the changed fourth battery-level information to the first operating system through the DCC modules in case that the fourth battery-level information changes. For example, the second operating system runs in the background and continuously calculates and obtains the fourth battery-level information; the fourth battery-level information is 49% at a certain time point, and reduced from 49% to 48% at the next time point; at this time, the second operating system sends the changed fourth battery-level information to the first operating system.

At block S407, the first operating system may take the fourth battery-level information as the current battery-level information, and display the current battery-level information in the first operating system.

When the first operating system runs in the foreground in a case where the second operating system is not completely shut down, that is, when the second operating system runs in the background, when the terminal device is switched back to the second operating system from the first operating system, the second operating system directly takes the fourth battery-level information as the first initial battery-level information of the second operating system in case that the terminal device is switched back to the second operating system from the first operating system, and displays the first initial battery-level information in the second operating system.

At block S408, after the second operating system is switched to the first operating system and the second operating system is shut down, the fifth battery-level information may be obtained.

The fifth battery-level information refers to the battery-level information calculated based on the first operating system.

In some embodiments, after the second operating system is switched to the first operating system and the second operating system is shut down, the terminal device only runs the first operating system, and the second operating system is neither run in the foreground nor in the background. In this case, the battery-level information is continuously calculated and updated based on the first operating system to obtain the fifth power level information.

At block S409, the first operating system may take the fifth battery-level information as the current battery-level information, and display the current battery-level information in the first operating system.

In some embodiments of the present disclosure, when the second operating system is switched to the first operating system, the third battery-level information before the second operating system is switched to the first operating system is obtained, then the third battery-level information is taken as the second initial battery-level information of the first operating system when the terminal device is switched to the first operating system, and the second initial battery-level information is displayed in the display interface. The operating system after switching may directly use and display the battery-level information displayed by the operating system before switching, which achieves the smooth transition in displaying the battery level when the second operating system is switched to the first operating system. In addition, after the second operating system is switched to the first operating system and the second operating system runs in the background, the current battery-level information is continuously calculated based on the second operating system to obtain the fourth battery-level information, and the first operating system takes the fourth battery-level information as the current battery-level information and further displays the fourth battery-level information in the display interface. In this case, the fourth battery-level information calculated by using the second operating system is displayed when the second operating system runs in the background, and the display result of the battery-level information is more accurate. Furthermore, after the second operating system is switched to the first operating system and the second operating system is shut down, the first operating system may continuously calculate and update the battery-level information to obtain the fifth battery-level information, the first operating system may further display the fifth battery-level information in the display interface of the first operating system, which reduces the occurrence of failure in displaying the battery-level information due to the shutdown of the second operating system and further ensures the display of the battery-level information.

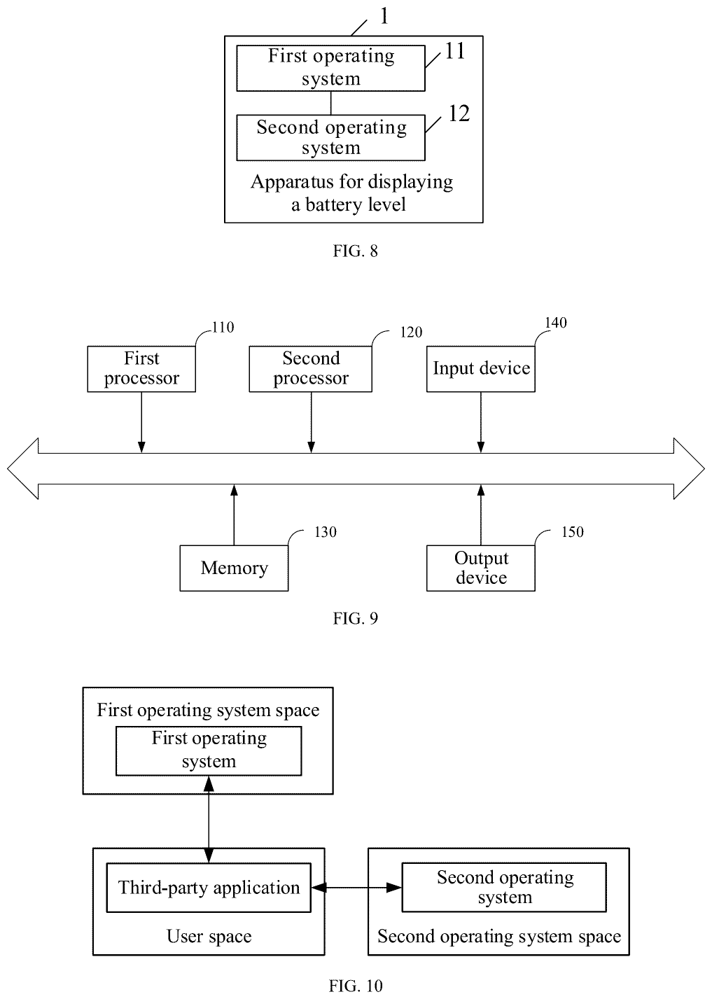

In the following, an apparatus for displaying a battery level according to some embodiments of the present disclosure may be described in details in junction with FIG. 8. It should be noted that, the apparatus for displaying the battery level shown in FIG. 8 is configured to perform the method illustrated in some embodiments shown in FIGS. 1 to 7 of the present disclosure. For the convenience of illustration, only parts of the apparatus related to some embodiments of the present disclosure are shown. The technical details of the apparatus not disclosed in FIG. 8 may refer to the embodiments of the present disclosure shown in FIGS. 1 to 7.

FIG. 8 is a structural block diagram of an apparatus for displaying a battery level according to some embodiments of the present disclosure. An apparatus 1 for displaying a battery level may be implemented in whole or in part by a software, a hardware, or a combination thereof. In some embodiments, the apparatus 1 for displaying a battery level may include a first operating system 11 and a second operating system 12. The power consumed by the terminal device running the first operating system 11 is less than the power consumed by the terminal device running the second operating system 12. Details are as follow.

The second operating system 12 is configured to obtain the first battery-level information before the first operating system is switched to the second operating system, and the first battery-level information may be obtained in response to the first operating system being switched to the second operating system.

The second operating system 12 is further configured to determine first initial battery-level information based on the first battery-level information, and display the first initial battery-level information in the second operating system.

In some embodiments, the second operating system 12 is further configured to obtain second battery-level information, and the second battery-level information is battery-level information at a time point when the second operating system is shut down.

The second operating system 12 is further configured to obtain difference in the battery-level information between the first battery-level information and the second battery-level information.

The second operating system 12 is further configured to determine the first initial battery-level information from the first battery-level information and the second battery-level information based on the difference in the battery-level information.

In some embodiments, the second operating system 12 is further configured to determine the second battery-level information as the first initial battery-level information, in a case where the difference in the battery-level information is less than or equal to the threshold.

The second operating system 12 is further configured to determine the first battery-level information as the first initial battery-level information, in a case where the difference in the battery-level information is greater than the threshold.

In some embodiments, the second operating system 12 is further configured to calculate the current battery-level information and determine the current battery-level information as the first initial battery-level information, in a case where the difference in the battery-level information is greater than the threshold.

The second operating system 12 is further configured to obtain third battery-level information, in response to the second operating system being switched to the first operating system, and the third battery-level information is the battery-level information before the second operating system is switched to the first operating system.

The second operating system 12 is further configured to send the third battery-level information to the first operating system.

The first operating system 11 is configured to take the third battery-level information as the second initial battery-level information, and display the second initial battery-level information in the first operating system.

In some embodiments, the second operating system 12 is further configured to continuously obtain the fourth battery-level information after the second operating system is switched to the first operating system, and the fourth battery-level information is the battery-level information before the second operating system is shut down and obtained in a case where the second operating system runs in the background.

The second operating system 12 is further configured to send the fourth battery-level information to the first operating system.

The first operating system 11 is further configured to take the fourth battery-level information as the current battery-level information, and display the current battery-level information in the first operating system.

In some embodiments, the first operating system 11 is further configured to obtain fifth battery-level information, after the second operating system is switched to the first operating system and the second operating system is shut down.

The first operating system 11 is further configured to take the fifth battery-level information as the current battery-level information, and display the current battery-level information in the first operating system.

In some embodiments, the second operating system 12 is further configured to obtain sixth battery-level information in response to detecting a power-on instruction, take the sixth battery-level information as the third initial battery-level information, and display the third initial battery-level information in the second operating system.

It should be noted that, the apparatus for displaying the battery level provided in the above-mentioned embodiments, when performing the method for displaying the battery level, is only illustrated by using the division of the above-described functional modules as an example. However, in practical application, the above-mentioned functions may be assigned to be accomplished by different functional modules as required, i.e., the internal structure of the apparatus may be divided into different functional modules to accomplish all or part of the functions as described above. In addition, the apparatus for displaying the battery level provided in the above embodiments and the method for displaying the battery level described in the above embodiments belong to the same concept, and the embodiments of the implementation of the apparatus may refer to the method embodiments, and will not be repeated herein.

The sequences of the above embodiments of the present disclosure are only for description and do not represent the advantages and disadvantages of the embodiments.

In some embodiments of the present disclosure, when the second operating system is switched to the first operating system, the first battery-level information at the time point when the first operating system is shut down and the second battery-level information before the second operating system is switched to the first operating system are obtained, the difference in the battery-level information is obtained based on the first battery-level information and the second battery-level information, the threshold is set, the first initial battery-level information is determined based on the difference in the battery-level information and the threshold, and the first initial battery-level information is displayed in the display interface. In this way, the smooth transition in displaying the battery level in response to the second operating system being switched to the first operating system may be achieved. When the first operating system is switched to the second operating system, the third battery-level information before the first operating system is switched is obtained, the third battery-level information is taken as the second initial battery-level information in response to the system being switched to the second operating system, and the second initial battery-level information is displayed in the display interface. In this case, the operating system after switching may directly use and display the battery-level information displayed by the operating system before switching, which achieves the smooth transition in displaying the battery level when the first operating system is switched to the second operating system.

Some embodiments of the present disclosure further provide a computer storage medium. The computer storage medium may store a plurality of instructions, and the instructions are adapted to be loaded by a processor to perform the method for displaying the battery level as disclosed in some embodiments shown in FIGS. 1 to 7. The execution process may refer to the descriptions to the embodiments shown in FIGS. 1 to 7, which will not be repeated herein.

FIG. 9 is a schematic structural diagram of a terminal device according to some embodiments of the present disclosure. As shown in FIG. 9, the terminal device may include one or more of the following components: a first processor 110, a second processor 120, a memory 130, an input device 140, an output device 150, and a bus 160. The first processor 110, the second processor 120, the memory 130, the input device 140, and the output device 150 are connected to each other via the bus 160.

The first processor 110 may include one or more processing cores, use various interfaces and lines to connect various parts in the entire terminal device. The first processor 110 may be configured to perform various functions of the terminal device 100 and process data by running or executing instructions, programs, code sets, or instruction sets stored in memory 130 and calling the data stored in memory 130. In some embodiments, the first processor 110 may be implemented in at least one hardware form such as a digital signal processing (DSP), a field-programmable gate array (FPGA), a programmable logic array (PLA). The first processor 110 may integrate one or a combination of at least one of the following components: a central processing unit (CPU), a graphics processing unit (GPU), and a modem, etc. The CPU is primarily configured to handle the first operating system and applications, etc. The GPU is configured to render and draw display contents. The modem is configured to address wireless communications. It can be understood that, the modem may not be integrated into the first processor 110, but instead be implemented through a separate communication chip.

Similarly, the second processor 120 may include one or more processing cores, use various interfaces and lines to connect various parts in the entire terminal device. The second processor 120 may be configured to perform various functions of the terminal device 100 and process data by running or executing instructions, programs, code sets or instruction sets stored in memory 130 and calling the data stored in memory 130. In some embodiments, the second processor 120 may be implemented in at least one hardware form such as a DSP, a FPGA, a PLA. The second processor 120 may integrate one or a combination of at least one of the following components: a CPU, a GPU, and a modem, etc. It is understood that, the modem may not be integrated into the first processor 110, but instead be implemented through a separate communication chip.

The memory 130 may include a random access memory (RAM) or a read-only memory (ROM). In some embodiments, the memory 130 may include a non-transitory computer-readable storage medium. The memory 130 may be configured to store instructions, programs, code, code sets, or instruction sets. The memory 130 may include a program storage area and a data storage area. The program storage area may be configured to store instructions for implementing the operating system, instructions for implementing at least one function (such as touch function, sound playback function, image playback function, etc.), instructions for implementing the method in some embodiments of the present disclosure described above, etc. The data storage area may be further configured to store data created by the terminal device during use, such as phone books, audio and video data, chat history data, etc.

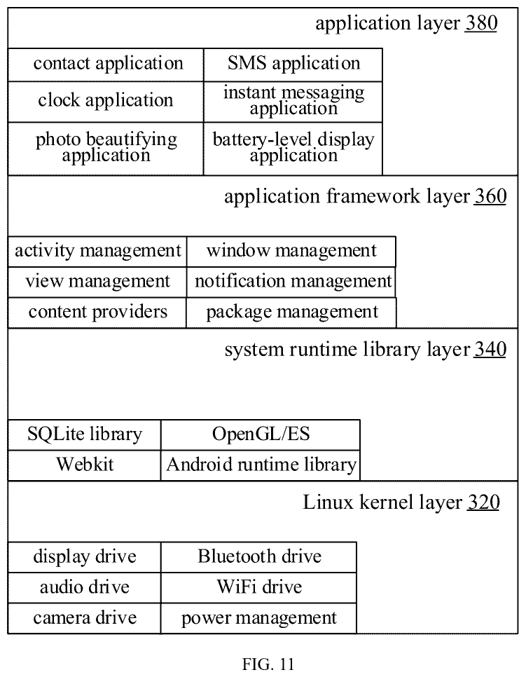

As shown in FIG. 10, the memory 130 may be divided into operating system space and user space. The operating system runs in the operating system space, and native and third-party applications run in the user space. The operating system space is divided into the first operating system space and the second operating system space, the first operating system runs in the first operating system space, and the second operating system runs in the second operating system space. In order to ensure that different third-party applications may achieve better running results, the first operating system or the second operating system assigns corresponding system resources to different third-party applications. However, the same third-party application has different requirements for the system resources in different application scenarios. For example, in the local resource loading scenario, the third-party application has higher requirements for disk read speed; in the animated rendering scenarios, the third-party application has higher requirements for the GPU performance. However, the first operating system, the second operating system, and the third-party application are independent of each other, and the operating systems cannot perceive the current application scenarios of the third-party application in time in most cases, resulting in the operating systems being unable to adapt the system resources based on the specific application scenarios of the third-party application.

In order to enable the first operating system and the second operating system to distinguish the specific application scenarios of the third-party application, it is necessary to enable the data communication between the third-party application and the operating systems, such that the first operating system and the second operating system may obtain the current scenario information of the third-party application at any time, and then the system resources may be adaptively assigned to the third-party application based on the current scenario.

Taking the first operating system as an Android system as an example, programs and data stored in the memory 130 are shown in FIG. 11. The memory 130 may store a Linux kernel layer 320, a system runtime library layer 340, an application framework layer 360, and an application layer 380. The Linux kernel layer 320, the system runtime library layer 340, and the application framework layer 360 belong to the first operating system space, and the application layer 380 belongs to the user space. The Linux kernel layer 320 provides an underlying drive for various hardware of the terminal device, such as a display drive, an audio drive, a camera drive, a Bluetooth drive, a WiFi drive, power management, etc. The system runtime library layer 340 provides main feature support for the Android system through a number of C/C++ libraries. For example, an SQLite library provides support for databases. An openGL/ES library provides support for 3D drawing. A Webkit library provides support for a browser kernel. In the system runtime library layer 340, an Android runtime library is further provided. The system runtime library layer 340 provides core libraries that allow developers to write Android applications using Java. The application framework layer 360 provides various Application Programming Interfaces (APIs) that may be configured to establish applications. Developers may also establish their own applications by using these APIs, such as activity management, window management, view management, notification management, content providers, package management, call management, resource management, and location management. The application layer 380 has at least one application running therein. The at least one application may be a native application configured in the first operating system, such as a contact application, a short message service (SMS) application, a clock application, a camera application, etc., or a third-party application developed by a third-party developer, such as a gaming application, an instant messaging application, a photo beautifying application, a battery-level display application, etc. The multimedia software may be a native application that comes with the first operating system, or an application developed by a third-party developer.

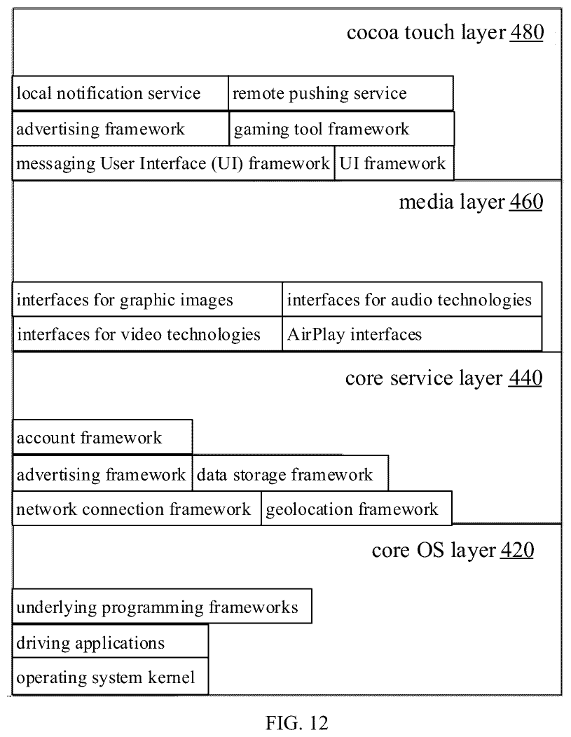

Taking the first operating system as an IOS system as an example, programs and data stored in the memory 130 are shown in FIG. 12. The IOS system includes a core OS layer 420, a core services layer 440, a media layer 460, and a cocoa touch layer 480. The core OS layer 420 includes the operating system kernel, driving applications, and underlying programming frameworks. The underlying programming frameworks provide functions similar to hardware, and may be used by the programming frameworks located in core services layer 440. The core service layer 440 provides system services and/or programming frameworks (such as a Foundation framework, an account framework, an advertising framework, a data storage framework, a network connection framework, a geolocation framework, a motion framework, etc.) to applications. The media layer 460 provides the application with interfaces for audio-visual aspects, such as interfaces for graphic images, interfaces for audio technologies, interfaces for video technologies, AirPlay interfaces for audios and videos, etc. The cocoa touch layer 480 provides a variety of interface-related frameworks for application development. The cocoa touch layer 480 is responsible for touch interaction operations between the user and the terminal device, such as a local notification service, a remote pushing service, an advertising framework, a gaming tool framework, a messaging User Interface (UI) framework, an UIKit framework, a mapping framework, etc.

For the frameworks shown in FIG. 12, frameworks relevant to most applications include, but are not limited to a base framework in the core service layer 440 and the UIKit framework in the cocoa touch layer 480. The base framework provides many basic object types and data types, provides basic system service for all the applications, and may be irrelevant with the UI. The UIKit framework provides basic UI class libraries for creating touch-based user interfaces. The IOS applications may provide UI based on the UIKit framework. Therefore, the UIKit framework provides the infrastructure of the application, and may be configured for building user interfaces, drawings, processing events interacting with the user, responding gestures, etc.

The method and principle of the third-party application communicating with the operating system in the IOS system may be referred to those of the Android operating system, which will not be repeated herein.

The input device 140 may be configured to receive input instructions or data. The input device 140 includes, but is not limited to, a keyboard, a mouse, a camera, a microphone, or a touch device. The output device 150 may be configured to output instructions or data. The output device 150 includes, but is not limited to, a displaying apparatus, a speaker, etc. For example, the input device 140 and the output device 150 may be combined. A touch display may be both the input device 140 and the output device 150. The touch display is configured to receive touch operations performed by the user using any suitable object (such as using a finger, a touch pen, etc.) on or near it. The touch display may display user interfaces of various applications. The touch display may be disposed on a front panel of the terminal device. The touch display may be designed as a full-screen, a curved screen, or an irregular-shaped screen. The touch display may be configured as a combination of the full screen and the curved screen, or a combination of the curved screen and the irregular-shaped screen, which will not be limited in some embodiments of the present disclosure.

In addition, those skilled in the art shall may understand that the structure of the terminal device shown in the accompanying figures does not limit the terminal device. The terminal device may include more or fewer components than shown in the figures. Alternatively, certain components may be combined, or components in the terminal device may be arranged in another manner. For example, the terminal device may further include a radio frequency circuit, an input unit, a sensor, an audio circuit, a Wireless Fidelity (WiFi) module, a power supply, a Bluetooth module, etc., which will not be described herein.

In some embodiments, the terminal device may be arranged with a display device. The displaying apparatus may be a variety of apparatuses that may achieve a displaying function, such as a Cathode Ray tube display (CR), a Light-Emitting Diode Display (LED), an e-ink screen, a Liquid Crystal Display (LCD), a Plasma Display Panel (PDP), etc. The user may use the display device on the terminal device 101 to view displayed texts, images, videos, and other information. The terminal device may be a smart phone, a tablet computer, a gaming device, an Augmented Reality (AR) device, a car, a data storage device, an audio playing device, a video playing device, a laptop, a desktop computing device, a wearable device such as an electronic watch, electronic glasses, an electronic helmet, an electronic bracelet, an electronic necklace, electronic clothing, etc.

In the terminal device shown in FIG. 9, the first processor 110 and the second processor 120 may be used together to call the battery-level display application stored in the memory 130 and perform the following operations:
in response to the first operating system being switched to the second operating system, obtaining first battery-level information, where the first battery-level information is battery-level information before the first operating system is switched; and
determining, by the second operating system, first initial battery-level information based on the first battery-level information, and displaying the first initial battery-level information in the second operating system.

In some embodiments, the first processor 110 and the second processor 120 may be used together to further perform the following operations:
obtaining, by the second operating system, second battery-level information, where the second battery-level information is the battery-level information at a time point when the second operating system is shut down; and
obtaining, by the second operating system, difference in the battery-level information between the first battery-level information and the second battery-level information.

The operation of determining, by the second operating system, first initial battery-level information based on the first battery-level information is performed by the second processor 120, and includes the following operations:
determining, by the second operating system, the first initial battery-level information from the first battery-level information and the second battery-level information based on the difference in the battery-level information.

In performing the operation of determining, by the second operating system, the first initial battery-level information from the first battery-level information and the second battery-level information based on the difference in the battery-level information, the second processor 120 may perform the following operations:
determining, by the second operating system, the second battery-level information as the first initial battery-level information, in a case where the difference in the battery-level information is less than or equal to the threshold; and
determining, by the second operating system, the first battery-level information as the first initial battery-level information, in a case where the difference in the battery-level information is greater than the threshold.

In some embodiments, in performing the operation of determining, by the second operating system, the first initial battery-level information from the first battery-level information and the second battery-level information based on the difference in the battery-level information, the second processor 120 may perform the following operations:
determining, by the second operating system, the second battery-level information as the first initial battery-level information, in a case where the difference in the battery-level information is less than or equal to the threshold; and
calculating, by the second operating system, current battery-level information and determining the current battery-level information as the first initial battery-level information, in a case where the difference in the battery-level information is greater than the threshold.

In some embodiments, the first processor 110 and the second processor 120 may be used together to call the battery-level display application stored in the memory 130 and perform the following operations:
obtaining, by the second operating system, third battery-level information, in response to the second operating system being switched to the first operating system; where the third battery-level information is the battery-level information before the second operating system is switched to the first operating system;
sending, by the second operating system, the third battery-level information to the first operating system; and
taking, by the first operating system, the third battery-level information as the second initial battery-level information, and displaying the second initial battery-level information in the first operating system.

In some embodiments, after performing the operation of taking, by the first operating system, the third battery-level information as the second initial battery-level information, and displaying the second initial battery-level information in the first operating system, the first processor 110 further performs the following operations:
continuously obtaining, by the second operating system, the fourth battery-level information, after the second operating system detecting that the second operating system is switched to the first operating system; where the fourth battery-level information is the battery-level information before the second operating system is shut down;
sending, by the second operating system, the fourth battery-level information to the first operating system; and
taking, by the first operating system, the fourth battery-level information as the current battery-level information, and displaying the current battery-level information in the first operating system.

In some embodiments, after performing the operation of taking, by the first operating system, the fourth battery-level information as the current battery-level information, and displaying the current battery-level information in the first operating system, the first processor 110 further performs the following operations:
obtaining, by the first operating system, fifth battery-level information, after the second operating system is switched to the first operating system and the second operating system is shut down; and
taking, by the first operating system, the fifth battery-level information as the current battery-level information, and displaying the current battery-level information in the first operating system.

In some embodiments, the first processor 110 and the second processor 120 may be used together to call the battery-level display application stored in the memory 130 and perform the following operations:
obtaining sixth battery-level information in response to detecting a power-on instruction, taking the sixth battery-level information as the third initial battery-level information, and displaying the third initial battery-level information in the second operating system.

In some embodiments of the present disclosure, when the second operating system is switched to the first operating system, the first battery-level information at the time point when the first operating system is shut down and the second battery-level information before the second operating system is switched are obtained, the difference in the battery-level information is obtained based on the first battery-level information and the second battery-level information, the threshold is set, the first initial battery-level information is determined based on the difference in the battery-level information and the threshold, and the first initial battery-level information is displayed in the display interface. In this way, the smooth transition in displaying the battery level in response to the second operating system being switched to the first operating system may be achieved. When the first operating system is switched to the second operating system, the third battery-level information before the first operating system is switched is obtained, the third battery-level information is taken as the second initial battery-level information in response to the system being switched to the second operating system, and the second initial battery-level information is displayed in the display interface. In this case, the operating system after switching may directly use and display the battery-level information displayed by the operating system before switching, which achieves the smooth transition in displaying the battery level when the first operating system is switched to the second operating system.

Those skilled in the art may clearly understand that the technical solution of the present disclosure may be realized with the help of software and/or hardware. The terms “unit” and “module” in some embodiments of the present disclosure refer to the software and/or hardware that may perform a specific function independently or in conjunction with other components, the hardware may be implemented as, e.g., an FPGA, an integrated circuit (IC), etc.

It should be noted that, for the sake of simplicity of description, each of the foregoing method embodiments is expressed as a series of combinations of operations. However, those skilled in the art should know that the present disclosure is not limited by the described sequence of operations, and some operations may be carried out in other sequences or simultaneously based on the present disclosure. Besides, those skilled in the art should also know that the embodiments described in the present disclosure are preferred embodiments, and the operations and modules involved are not necessarily necessary for the present disclosure.

In the above embodiments, the descriptions of each embodiment have their own emphasis, and the part that is not detailed in a certain embodiment may refer to the relevant descriptions of other embodiments.

In some embodiments provided by the present disclosure, it should be understood that the disclosed apparatus may be implemented in other ways. For example, the embodiments regarding the apparatus described above are merely illustrative, and the division of units is just one logical functional division. In practical implementation, there may be other ways of division, such as multiple units or components being combined or integrated into another system, or some features can be omitted or not executed. Another point is that the couplings or direct couplings or communication connections discussed or shown may be indirect couplings or communication connections through service interfaces, apparatuses, or units, and may be electrical or in other forms.

Units described as separate components may or may not be physically separated, and components shown as units may or may not be physical units, meaning they may be located in one place or distributed across multiple network units. Depending on practical needs, some or all of the units can be selected to implement the objectives of some embodiments of the present disclosure.

Moreover, in each embodiment of the present disclosure, the functional units may be integrated into a processing unit, or they may exist physically separately, or two or more units may be integrated into one unit. The integrated units may be implemented in hardware form or as software functional units.

If the integrated units are implemented in the form of software functional units and sold or used as independent products, they may be stored in a computer-readable storage medium. Based on this understanding, the technical solutions of the present disclosure, or parts of the contribution to the existing technology, may be embodied in the form of software products. The computer software product is stored in a storage medium, including several instructions to make a computer device (which may be a personal computer, a server, or a network device, etc.) execute all or part of the operations of the method in the various embodiments of the present disclosure. The aforementioned storage mediums include a USB drive, an ROM, an RAM, a portable hard disk, a diskette, an optical disc, and other mediums that are capable of storing program codes.

Those skilled in the art may understand that all or part of the operations in the various methods of the above embodiments may be completed by instructing the relevant hardware through one or more programs. The programs may be stored in a computer-readable memory, and the memory may include: a flash disk, an ROM, an RAM, a diskette, an optical disc, etc.

The foregoing are only exemplary embodiments of the present disclosure, and do not limit the scope of the present disclosure. Any equivalent changes and modifications made in accordance with the teachings of the present disclosure are still within the scope of the present disclosure. Those skilled in the art will be apt to think of other embodiments of the present disclosure after considering the present disclosure and practice of the present disclosure. The present application is intended to cover any variations, uses, or adaptations of the present disclosure that follow the general principles of the present disclosure and that include common knowledge or customary technical means in the art that are not described in the present disclosure. The specification and embodiments are considered to be illustrative only, and the scope and the spirit of the present disclosure are limited by the claims.

1. A method for displaying a battery level, performed by a terminal device, the terminal device comprising a first operating system and a second operating system, power consumed by the terminal device running the first operating system being less than power consumed by the terminal device running the second operating system; the method comprising:
obtaining first battery-level information in response to the first operating system being switched to the second operating system, wherein the first battery-level information is battery-level information before the first operating system is switched;
determining, by the second operating system, first initial battery-level information based on the first battery-level information; and
displaying the first initial battery-level information in the second operating system.

2. The method as claimed in claim 1, wherein the obtaining first battery-level information, comprises:
sending, by the second operating system, a request for obtaining battery-level information; and
sending, by the first operating system, the first battery-level information to the second operating system, in response to receiving the request for obtaining battery-level information.

3. The method as claimed in claim 1, further comprising:
obtaining, by the second operating system, second battery-level information, wherein the second battery-level information is battery-level information at a time point when the second operating system is shut down; and
obtaining, by the second operating system, difference in the battery-level information between the first battery-level information and the second battery-level information; and
wherein the determining, by the second operating system, first initial battery-level information based on the first battery-level information, comprises:
determining, by the second operating system, the first initial battery-level information from the first battery-level information and the second battery-level information based on the difference in the battery-level information.

4. The method as claimed in claim 1, further comprising:
obtaining third battery-level information in response to the second operating system being switched to the first operating system, wherein the third battery-level information is battery-level information before the second operating system is switched;
sending, by the second operating system, the third battery-level information to the first operating system; and
taking, by the first operating system, the third battery-level information as second initial battery-level information, and displaying the second initial battery-level information in the first operating system.

5. The method as claimed in claim 4, wherein after the taking, by the first operating system, the third battery-level information as second initial battery-level information, and displaying the second initial battery-level information in the first operating system, the method further comprises:
continuously obtaining fourth battery-level information, after the second operating system is switched to the first operating system; wherein the fourth battery-level information is battery-level information in a case where the second operating system runs in the background and before the second operating system is shut down;
sending, by the second operating system, the fourth battery-level information to the first operating system; and
taking, by the first operating system, the fourth battery-level information as current battery-level information, and displaying the current battery-level information in the first operating system.

6. The method as claimed in claim 5, wherein the sending, by the second operating system, the fourth battery-level information to the first operating system, comprises:
sending the fourth battery-level information to the first operating system, in a case where the fourth battery-level information changes.

7. The method as claimed in claim 5, wherein after the taking, by the first operating system, the fourth battery-level information as current battery-level information, and displaying the current battery-level information in the first operating system, the method further comprises:
obtaining fifth battery-level information, after the second operating system is switched to the first operating system and the second operating system is shut down; and
taking, by the first operating system, the fifth battery-level information as the current battery-level information, and displaying the current battery-level information in the first operating system.

8. The method as claimed in any one of claims 1-7, further comprising:
obtaining sixth battery-level information in response to detecting a power-on instruction;
taking the sixth battery-level information as third initial battery-level information; and
displaying third initial battery-level information in the second operating system.

9. The method as claimed in claim 3, wherein the determining, by the second operating system, the first initial battery-level information from the first battery-level information and the second battery-level information based on the difference in the battery-level information, comprises:
determining, by the second operating system, the second battery-level information as the first initial battery-level information, in a case where the difference in the battery-level information is less than or equal to a threshold; and
determining, by the second operating system, the first battery-level information as the first initial battery-level information, in a case where the difference in the battery-level information is greater than the threshold.

10. The method as claimed in claim 3, wherein the determining, by the second operating system, the first initial battery-level information from the first battery-level information and the second battery-level information based on the difference in the battery-level information, comprises:
determining, by the second operating system, the second battery-level information as the first initial battery-level information, in a case where the difference in the battery-level information is less than or equal to a threshold; and
calculating, by the second operating system, current battery-level information and determining the current battery-level information as the first initial battery-level information, in a case where the difference in the battery-level information is greater than the threshold.

11. A n apparatus for displaying a battery level, comprising:
a second operating system, configured to:
obtain first battery-level information in response to the first operating system being switched to the second operating system, wherein the first battery-level information is battery-level information before the first operating system is switched;
determine first initial battery-level information based on the first battery-level information; and
display the first initial battery-level information in the second operating system.

12. The apparatus for displaying the battery level as claimed in claim 11, wherein the second operating system is further configured to:
obtain second battery-level information at a time point, wherein the second battery-level information is battery-level information when the second operating system is shut down;
obtain difference in the battery-level information between the first battery-level information and the second battery-level information; and
determine the first initial battery-level information from the first battery-level information and the second battery-level information based on the difference in the battery-level information in determining the first initial battery-level information based on the first battery-level information.

13. The apparatus for displaying the battery level as claimed in claim 11, wherein the second operating system is further configured to:
obtain third battery-level information in response to the second operating system being switched to the first operating system, wherein the third battery-level information is battery-level information before the second operating system is switched; and
send the third battery-level information to the first operating system; and
wherein the first operating system is further configured to:
take the third battery-level information as second initial battery-level information, and display the second initial battery-level information in the first operating system.

14. The apparatus for displaying the battery level as claimed in claim 13, wherein the second operating system is further configured to:
continuously obtain fourth battery-level information, after the second operating system is switched to the first operating system, wherein the fourth battery-level information is the battery-level information in a case where the second operating system runs in the background and before the second operating system is shut down; and
send the fourth battery-level information to the first operating system; and
wherein the first operating system is further configured to:
take the fourth battery-level information as the current battery-level information, and display the current battery-level information in the first operating system.

15. The apparatus for displaying the battery level as claimed in claim 13, wherein the first operating system is further configured to:
obtain fifth battery-level information, after the second operating system is switched to the first operating system and the second operating system is shut down; and
take the fifth battery-level information as the current battery-level information, and display the current battery-level information in the first operating system.

16. The apparatus for displaying the battery level as claimed in any one of claims 11-15, wherein the second operating system is further configured to:
obtain sixth battery-level information in response to detecting a power-on instruction;
take the sixth battery-level information as the third initial battery-level information; and
display the third initial battery-level information in the second operating system.

17. The apparatus for displaying the battery level as claimed in claim 12, wherein the second operating system is further configured to:
determine the second battery-level information as the first initial battery-level information, in a case where the difference in the battery-level information is less than or equal to the threshold; and
determine the first battery-level information as the first initial battery-level information, in a case where the difference in the battery-level information is greater than the threshold.

18. The apparatus for displaying the battery level as claimed in claim 12, wherein the second operating system is further configured to:
determine the second battery-level information as the first initial battery-level information, in a case where the difference in the battery-level information is less than or equal to the threshold; and
calculate the current battery-level information and determine the current battery-level information as the first initial battery-level information, in a case where the difference in the battery-level information is greater than the threshold.

19. A storage medium, storing a computer program which, when executed by a processor, causes the processor to perform the method as claimed in any one of claims 1-10.

20. A terminal device, comprising a processor and a memory storing a computer program, wherein the computer program is configured to be loaded and executed by the processor to perform the method as claimed in any one of claims 1-10.
